(19) United States
(12) Patent Application Publication
(10) Pub. No.: US 2023/0179262 A1
(43) Pub. Date: Jun. 8, 2023

(54) RADIO COMMUNICATION APPARATUS, CONTROL CIRCUIT, STORAGE MEDIUM, AND SIGNAL PROCESSING METHOD

(71) Applicant: Mitsubishi Electric Corporation, Tokyo (JP)

(72) Inventors: Hiroshi NISHIMOTO, Tokyo (JP); Shunsuke UEHASHI, Tokyo (JP)

(73) Assignee: Mitsubishi Electric Corporation, Tokyo (JP)

(21) Appl. No.: 18/163,776

(22) Filed: Feb. 2, 2023

Related U.S. Application Data
(63) Continuation of application No. PCT/JP2020/035223, filed on Sep. 17, 2020.

(51) Int. Cl. H04B 7/024; H04W 16/28

(52) U.S. Cl. CPC H04B 7/024; H04W 16/28

(57) ABSTRACT

A radio communication apparatus includes an estimator that estimates virtual cell identification information, channel responses for each antenna, and arrival delay amounts for each antenna, a selector that calculates the channel power level of each ground base station from the channel responses, calculates the arrival delay amount of each ground base station from the arrival delay amounts, and selects one or more desired ground base stations and interference ground base stations from the virtual cell identification information, the channel power levels, and the arrival delay amounts, a combiner that, based on the number of the antennas, combines the channel responses of the desired ground base stations into one effective desired channel matrix, and combines the channel responses of the interference ground base stations into one effective interference channel matrix, and a controller that controls directivity using the effective desired channel matrix and the effective interference channel matrix.

### CROSS-REFERENCE TO RELATED APPLICATION

This application is a continuation application of International Application PCT/JP2020/035223, filed on Sep. 17, 2020, and designating the U.S., the entire contents of which are incorporated herein by reference.

### BACKGROUND OF THE INVENTION

### 1. Field of the Invention

The present disclosure relates to a radio communication apparatus, a control circuit, a storage medium, and a signal processing method used in a wireless communication system in which a plurality of ground base stations wirelessly communicates with mobile stations, using the same frequencies.

### 2. Description of the Related Art

Wireless communication systems has a multi-station simultaneous transmission technology for forming a cell having an expanded cell range (hereinafter referred to as a large cell for distinction from the original cell). While a single base station (BS) forms a cell size having a limited range, the multi-station simultaneous transmission technology is a scheme that allows a plurality of BSs to handle the same signals with the same frequencies, thereby virtually forming a large cell. The multi-station simultaneous transmission technology is also called a single-frequency network (SFN). The multi-station simultaneous transmission technology allows efficient information distribution, particularly in multicasting, broadcasting, etc. in which the same information is provided to a plurality of mobile stations (MSs). When different BSs form different cells in a communication service directed to an MS moving at high speed, the MS needs to frequently switch to an adjacent cell, that is, perform handover, which results in a decrease in communication efficiency. However, applying multi-station simultaneous transmission to the communication service directed to the high-speed moving MS makes it possible to reduce the frequency of handover and hence improve communication efficiency. A large cell virtually formed by a plurality of BSs using multi-station simultaneous transmission is hereinafter referred to as a zone.

From the standpoint of efficient frequency utilization, it is desirable to use the same radio frequencies even in different zones. The allocation of the same radio frequencies to different cells, zones, etc. is called one-frequency repetition, reuse 1, etc. As adjacent cells, zones, etc. use the same radio frequencies, a boundary area between the adjacent cells, the zones, etc., that is, an area called a cell edge or a zone edge suffers from a problem of interference. Measures against such interference in the boundary areas are, for example, to provide an MS with a plurality of antennas called a multi-antenna or an array antenna and control directivity to thereby suppress the interference. Directivity control by an array antenna is called spatial filtering. The number of antennas of an array antenna is called the degree of freedom of the array. An MS can perform proper directivity control by including a number of antennas larger than or equal to the sum of the number of desired signals that should be extracted and the number of interference signals that should be suppressed.

Japanese Translation of PCT International Application Laid-open No. 2005-535255 discloses a technique that allows an antenna system including a plurality of antennas capable of forming a plurality of beams to determine one beam and then adjust the other beams so as to expand a range in which a maximum data speed can be achieved.

Unfortunately, the technique described in Japanese Translation of PCT International Application Laid-open No. 2005-535255 can be implemented as the beams are adjusted in a situation where a wireless communication environment does not change; and thus, it is difficult to apply such a technique to mobile communication. Further, the number of antennas that can be installed in a mobile station is generally limited by installation space, device constraints, etc. Furthermore, a plurality of desired signals and a plurality of interference signals may arrive at a mobile station in the boundary area, and the number of the arriving signals may exceed the number of the installed antennas. In such a situation, it is difficult for an MS to perform proper directivity control, which results in a problem of interference in the boundary area.

### SUMMARY OF THE INVENTION

To solve the above problem and achieve the object, the present disclosure provides a radio communication apparatus in a wireless communication system including a plurality of ground base stations handling the same signals with the same frequencies to form a virtual cell, and an adjacent virtual cell also using the same frequencies, the radio communication apparatus receiving the same signals, using a plurality of antennas. The radio communication apparatus comprises: a channel estimator to estimate virtual cell identification information, channel responses for each antenna, and arrival delay amounts for each antenna, the virtual cell identification information identifying the virtual cell to which the ground base stations belong; a channel selector to calculate a channel power level of each ground base station from the channel responses for each antenna, calculate an arrival delay amount of each ground base station from the arrival delay amounts for each antenna, and select one or more desired ground base stations and interference ground base stations from the virtual cell identification information, the channel power levels, and the arrival delay amounts; a channel combiner to, on a basis of the number of the antennas, combine the channel responses of one or more of the ground base stations into one effective desired channel matrix, and combine the channel responses of one or more of the ground base stations into one effective interference channel matrix, the one or more of the ground base stations being the desired ground base stations, the one or more of the ground base stations being the interference ground base stations; and a directivity controller to control directivity, using the effective desired channel matrix and the effective interference channel matrix.

### BRIEF DESCRIPTION OF THE DRAWINGS

FIG. 1 is a diagram illustrating an example configuration of a wireless communication system according to a first embodiment;

FIG. 2 is a block diagram illustrating an example configuration of a radio communication apparatus according to the first embodiment;

FIG. 3 is a flowchart illustrating the operation of the radio communication apparatus according to the first embodiment;

FIG. 4 is a diagram illustrating a map of the arrival delay amount and the channel power level of each BS obtained by a channel selector of the radio communication apparatus according to the first embodiment;

FIG. 5 is a flowchart illustrating the operation of the channel selector of the radio communication apparatus according to the first embodiment;

FIG. 6 is a diagram illustrating an example configuration of processing circuitry when a processor and memory implement processing circuitry included in the radio communication apparatus according to the first embodiment;

FIG. 7 is a diagram illustrating an example of processing circuitry when dedicated hardware constitutes the processing circuitry included in the radio communication apparatus according to the first embodiment;

FIG. 8 is a diagram illustrating an example configuration of a wireless communication system according to a second embodiment; and

FIG. 9 is a diagram illustrating a map of the arrival delay amount and the channel power level of each BS obtained by a channel selector of a radio communication apparatus according to the second embodiment.

### DETAILED DESCRIPTION OF THE PREFERRED EMBODIMENTS

A radio communication apparatus, a control circuit, a storage medium, and a signal processing method according to embodiments of the present disclosure will be hereinafter described in detail with reference to the drawings.

### First Embodiment

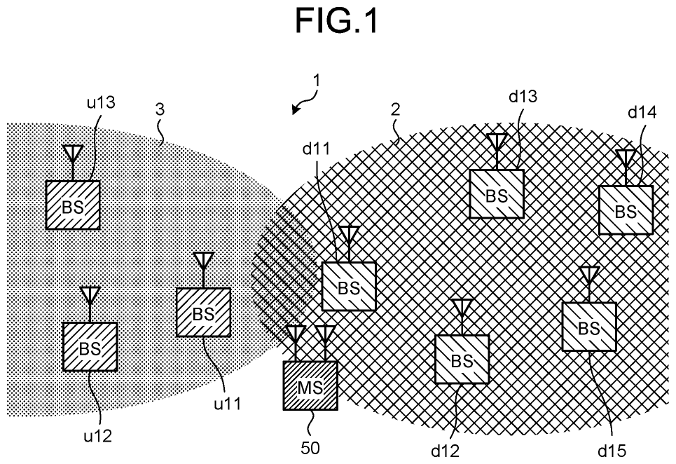

FIG. 1 is a diagram illustrating an example configuration of a wireless communication system 1 according to a first embodiment. The wireless communication system 1 includes a mobile station (hereinafter, referred to as an MS) 50 and ground base stations (hereinafter, referred to as BSs) d11 to d15 and u11 to u13. In FIG. 1, the MS 50 belongs to a desired cell 2 that is a virtual cell formed by the BSs d11 to d15. As illustrated in FIG. 1, the MS 50 is in a boundary area of the desired cell 2. Thus, for the MS 50, a virtual cell formed by the BSs u11 to u13 is an interference cell 3. In the following description, the BSs d11 to d15 and u11 to u13 are sometimes simply referred to as BSs when not distinguished. FIG. 1 illustrates an image of the positional relationships between the MS 50 and the BSs in the wireless communication system 1. The wireless communication system 1 is a system including a plurality of BSs and an adjacent virtual cell. The BSs handle the same signals with the same frequencies to form a virtual cell. The adjacent virtual cell also uses the same frequencies. In FIG. 1, the number of BSs belonging to the desired cell 2 is five, and the number of BSs belonging to the interference cell 3 is three, which is an example. The number of BSs belonging to each cell is not limited to the example of FIG. 1.

The number of antennas of each BS is referred to as Ntx, and the number of antennas of the MS 50 is referred to as Nrx. The present embodiment will be described taking Ntx=1 as an example. In the present embodiment, Nrx is two or more because the MS 50 performs directivity control. The description will be made taking Nrx=2 as an example for the purpose of simplicity. That is, in the present embodiment, the MS 50 has two degrees of freedom of an array, and the MS 50 can form two different directivities. In FIG. 1, the antennas are illustrated as being provided on the outside of the BSs and the MS 50, but the antennas are defined as being included in the BSs and the MS 50. The same applies to the following embodiments.

As illustrated in FIG. 1, the BSs in the desired cell 2 observable from the MS 50 are five stations BS d11 to the BS d15, and the BSs in the interference cell 3 observable from the MS 50 are three stations BS u11 to the BS u13. Thus, the MS 50 receives transmission signals from the BSs d11 to d15 in the desired cell 2 as desired signals, and signals from the BSs u11 to u13 in the interference cell 3 are interference. The present embodiment will be described taking, for example, downlink communication in which the BSs transmit signals and the MS 50 receives the signals.

A radio frame, which is a downlink communication signal transmitted from each BS, has a data signal inserted therein. In addition, a reference signal sequence for estimating channel information is inserted in the radio frame. In the wireless communication system 1, each BS is assigned an individual reference signal sequence. By virtue of the reference signal sequence, thus, the MS 50 can identify each BS and estimate individual channel information. Assume that the MS 50 also knows virtual cell identification information for identifying the cell to which each BS belongs. The virtual cell identification information is, for example, an identifier such as an ID that can identify the virtual cell. The channel information includes the complex amplitude value of a radio transmission path, i.e., a channel response, and an arrival delay amount. The channel response generally varies due to the fading of radio wave propagation. The arrival delay amount varies due to a physical transmission distance, positional relationship, radio wave propagation, etc. between the BS and the MS 50. Generally, the larger the distance, the larger the arrival delay amount.

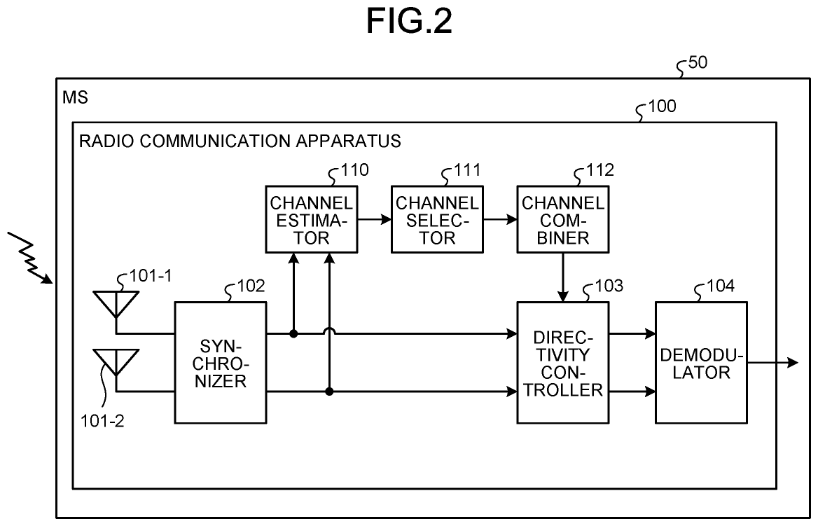

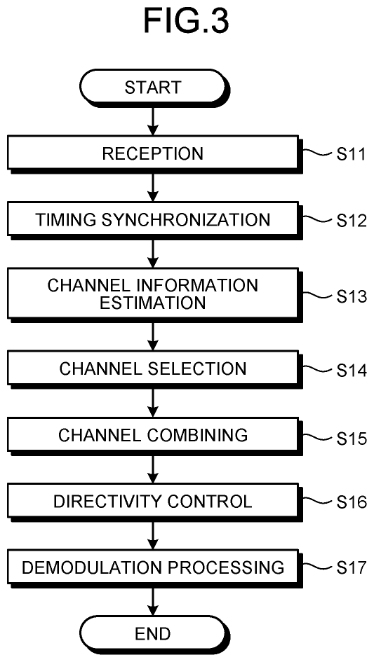

A radio communication apparatus of the MS 50 will be described. FIG. 2 is a block diagram illustrating an example configuration of a radio communication apparatus 100 according to the first embodiment. The radio communication apparatus 100, which is a receiving apparatus used in the MS 50 in the wireless communication system 1, receives radio frames, i.e., signals transmitted from the BSs, using a plurality of antennas. As illustrated in FIG. 2, the radio communication apparatus 100 includes antennas 101-1 and 101-2, a synchronizer 102, a directivity controller 103, a demodulator 104, a channel estimator 110, a channel selector 111, and a channel combiner 112. FIG. 3 is a flowchart illustrating the operation of the radio communication apparatuses 100 according to the first embodiment.

The antennas 101-1 and 101-2 receive signals transmitted from the BSs (step S11). The antennas 101-1 and 101-2 output the received signals to the synchronizer 102. In the following description, the antennas 101-1 and 101-2 are sometimes referred to as antennas 101 when not distinguished. As described above, the MS 50, that is, the radio communication apparatus 100 includes the two antennas 101 (Nrx=2).

The synchronizer 102 performs timing synchronization, using the signals received by the antennas 101 (step S12), and detects radio frames from the received signals. The synchronizer 102 outputs the detected radio frames to the channel estimator 110. The synchronizer 102 also outputs the received signals to the directivity controller 103. The synchronizer 102 may perform frequency synchronization in addition to timing synchronization.

The channel estimator 110 extracts reference signal sequences from the radio frames detected by the synchronizer 102 and estimates channel information (step S13). The channel estimator 110 outputs, to the channel selector 111, channel information estimate values that are estimated channel information. Specifically, on the basis of the reference signal sequences of the radio frames included in the received signals, the channel estimator 110 estimates the channel information, that is, estimates virtual cell identification information, channel responses for each antenna 101 of the MS 50, and arrival delay amounts for each antenna 101 of the MS 50. The virtual cell identification information identifies the virtual cells to which the BSs belong.

The channel selector 111 performs channel selection that selects significant desired channel response elements and significant interference channel response elements, from the channel information estimate values estimated by the channel estimator 110 (step S14). The channel selector 111 outputs, to the channel combiner 112, the selected significant desired channel response elements as desired BSs, and the selected significant interference channel response elements as interference BSs. Specifically, the channel selector 111 calculates the channel power level of each BS from the channel responses for each antenna 101 of the MS 50, and calculates the arrival delay amount for each BS from the arrival delay amounts for each antenna 101 of the MS 50. The channel selector 111 selects one or more desired BSs and one or more interference BSs from the virtual cell identification information, the channel power levels, and the arrival delay amounts.

The channel combiner 112 combines or degenerates the desired BSs and the interference BSs selected by the channel selector 111, in such a manner as to allow directivity control with the degree of freedom of the array, thereby obtaining an effective desired channel matrix and an effective interference channel matrix. The channel combiner 112 outputs the effective desired channel matrix and the effective interference channel matrix to the directivity controller 103. Specifically, on the basis of the number of the antennas 101 of the MS 50, the channel combiner 112 performs channel combining that combines the desired BSs, i.e., the channel responses of the one or more BSs into one effective desired channel matrix, and combines the interference BSs, i.e., the channel responses of the one or more BSs into one effective interference channel matrix (step S15).

The directivity controller 103 calculates directivity control weights from the effective desired channel matrix and the effective interference channel matrix provided by the channel combiner 112, and multiplies the received signals acquired from the synchronizer 102 by the calculated directivity control weights. Thus, the directivity controller 103 performs directivity control on the antennas 101 of the radio communication apparatus 100, using the effective desired channel matrix and the effective interference channel matrix (step S16).

The demodulator 104 performs demodulation processing to detect data from the received signals subjected to the directivity control by the directivity controller 103 (step S17). Assume that the demodulator 104 performs detection processing on digitally modulated signals such as phase-shift-keying (PSK) modulated signals or quadrature-amplitude-modulation (QAM) modulated signals.

Next, the operations of the channel selector 111 and the channel combiner 112, which characterize the present embodiment, will be described in detail.

The channel selector 111 extracts the virtual cell identification information on each BS, the channel power level of each BS, and the arrival delay amount of each BS, from the channel information estimate values estimated by the channel estimator 110. The virtual cell identification information enables the channel selector 111 to determine whether the BS of the corresponding channel is a BS in the desired cell 2 or a BS in the interference cell 3. Since the channel response value for each antenna 101 of the MS 50 has been obtained BS-by-BS, the channel selector 111 adds up the powers for the Nrx antennas to thereby provide the channel power level of each BS. Since the value for each antenna 101 of the MS 50 has also been obtained regarding the arrival delay amount of each BS, the channel selector 111 averages the values for the individual antennas 101 to thereby provide the arrival delay amount of each BS. Alternatively the channel selector 111 weights the values for the individual antennas 101 with the channel powers and adds up the thus weighted values, thereby providing the arrival delay amount of each BS.

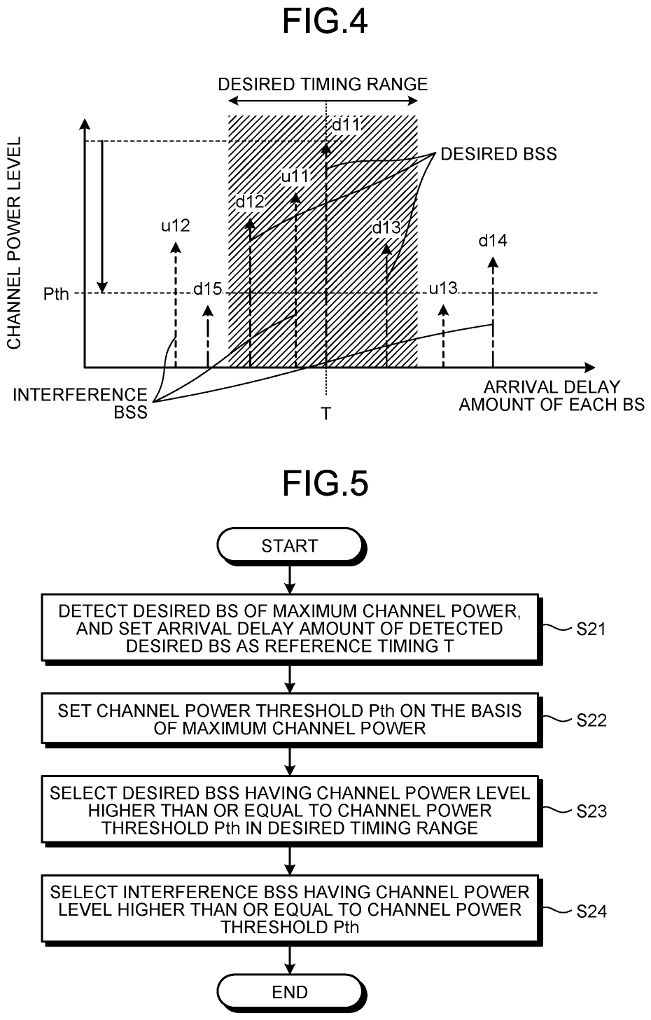

From these pieces of information, the channel selector 111 can obtain a map indicating the arrival delay amount and the channel power level on a per BS basis, as illustrated in FIG. 4. FIG. 4 is a diagram illustrating the map of the arrival delay amount and the channel power level of each BS obtained by the channel selector 111 of the radio communication apparatus 100 according to the first embodiment. On the basis of the map of the arrival delay amount and the channel power level of each BS illustrated in FIG. 4, a channel selection procedure in the channel selector 111 will be described. FIG. 5 is a flowchart illustrating the operation of the channel selector 111 of the radio communication apparatus 100 according to the first embodiment.

The channel selector 111 detects a desired BS of the maximum channel power having the highest channel power level, and sets the arrival delay amount of the detected desired BS as a reference timing T (step S21). In the example of FIG. 4, the channel power level of the BS d11, which is a BS in the desired cell 2, is the highest. Thus, the channel selector 111 detects the BS d11 as the desired BS of the maximum channel power, and sets the arrival delay amount of the BS d11 as the reference timing T. The channel selector 111 sets a desired timing range that is a range of ±Δt centering the reference timing T. Assume that the channel selector 111 regards a desired BS outside the desired timing range as an interference BS because the desired BS outside the desired timing range can cause interference due to a long delay.

The channel selector 111 sets a channel power threshold Pth with reference to the channel power level of the BS d11, that is, the maximum channel power (step S22).

The channel selector 111 selects desired BSs having a channel power level higher than or equal to the channel power threshold Pth in the desired timing range [T−Δt to T+Δt] (step S23). The desired BSs are BSs belonging to the desired cell 2. Since the BS d11 corresponds to a BS exceeding the channel power threshold Pth within the desired timing range, at least one or more stations are selected. The channel selector 111 will select M desired BSs where M is the number of desired BSs to be selected. The channel selector 111 will select Mmax desired BSs where Mmax is the maximum number of desired BSs to be selected in that step. Note that 1≤M≤Mmax.

Finally, the channel selector 111 selects interference BSs having a channel power level higher than or equal to the channel power threshold Pth (step S24). Assume that the channel selector 111 also regards a desired BS outside the desired timing range as an interference BS as described above, and selects at least one station to maximum Nmax stations. When there are no corresponding interference BSs, the channel selector 111 selects an interference BS having the highest power. The channel selector 111 will select N interference BSs where N is the number of interference BSs to be selected. The channel selector 111 will select Nmax interference BSs where Nmax is the maximum number of interference BSs to be selected in that step. Note that 1≤N≤Nmax.

Through the operation of the flowchart illustrated in FIG. 5, the channel selector 111 selects the three BSs d11, d12, and d13 (M=3) as desired BSs, and selects the three BSs u11, u12, and d14 (N=3) as interference BSs, as illustrated in FIG. 4.

Next, the operation of the channel combiner 112 will be described. First, the channel combiner 112 defines channel response vectors for the BSs selected by the channel selector 111. As regards the desired BSs, the channel response vector between the BS d11 and the MS 50 is defined as h_{d11}, the channel response vector between the BS d12 and the MS 50 as h_{d12}, and the channel response vector between the BS d13 and the MS 50 as h_{d13}. Likewise, regarding the interference BSs, the channel response vector between the BS u11 and the MS 50 is defined as hᵤ₁₁, the channel response vector between the BS u12 and the MS 50 as hᵤ₁₂, and the channel response vector between the BS d14 and the MS 50 as h_{d14}. The channel combiner 112 defines elements of these channel response vectors, as expressed in formula (1).

$$\begin{matrix}Formula 1 & \\ {h}_{d 11} = [ \begin{matrix}{h}_{d 11 , 1} \\ {h}_{d 11 , 2}\end{matrix} ] , {h}_{d 12} = [ \begin{matrix}{h}_{d 12 , 1} \\ {h}_{d 12 , 2}\end{matrix} ] , {h}_{d 13} = [ \begin{matrix}{h}_{d 13 , 1} \\ {h}_{d 13 , 2}\end{matrix} ] & ( 1 )\end{matrix}$$

$${h}_{u 11} = [ \begin{matrix}{h}_{u 11 , 1} \\ {h}_{u 11 , 2}\end{matrix} ] , {h}_{u 12} = [ \begin{matrix}{h}_{u 12 , 1} \\ {h}_{u 12 , 2}\end{matrix} ] , {h}_{d 14} = [ \begin{matrix}{h}_{d 14 , 1} \\ {h}_{d 14 , 2}\end{matrix} ]$$

Next, the channel combiner 112 defines a 2×3 desired channel matrix H_{d1} having the channel response vectors of the selected desired BSs arranged in the column direction as expressed in formula (2).

Formula 2:

H_{d1}=[h_{d11}h_{d12}h_{d13}] (2)

Likewise, the channel combiner 112 defines a 2×3 interference channel matrix Hᵤₗ having the channel response vectors of the selected interference BSs arranged in the column direction as expressed in formula (3).

Formula 3:

Hᵤ₁=[hᵤ₁₁hᵤ₁₂hᵤ₁₄] (3)

In both the 2×3 desired channel matrix H_{d1} in formula (2) and the 2×3 interference channel matrix Hᵤ₁ in formula (3), the matrix row direction corresponds to the antenna space of the MS 50, and the matrix column direction corresponds to the antenna space of the BSs. The 2×3 desired channel matrix H_{d1} in formula (2) has two singular values or eigenvalues. For this reason, the channel combiner 112 can extract singular values and singular vectors by the singular value decomposition of H_{d1}, or can extract eigenvalues and eigenvectors by the eigenvalue decomposition of H_{d1}H_{d1}^{H}. Sign “H” located at the upper right of H_{d1}^{H} indicates Hermitian transposition. The same applies to the following. The channel combiner 112 is defined as performing the latter decomposition, i.e., the eigenvalue decomposition of H_{d1}H_{d1}^{H} by way of example, as expressed in formula (4).

$$\begin{matrix}Formula 4 & \\ {H}_{d 1} {H}_{d 1}^{H} = [ {u}_{d 1 , 1} {u}_{d 1 , 2} ] [ \begin{matrix}{λ}_{d 1 , 1} & 0 \\ 0 & {λ}_{d 1 , 2}\end{matrix} ] [ \begin{matrix}{u}_{d 1 , 1}^{H} \\ {u}_{d 1 , 2}^{H}\end{matrix} ] & ( 4 )\end{matrix}$$

λ_{d1,1} and λ_{d1,2} are eigenvalues, and u_{d1,1} and u_{d1,2} are eigenvectors. Using these eigenvalues and eigenvectors, the channel combiner 112 obtains a 2×2 effective desired channel matrix H (with sign “-” above H) d1 as in formula (5). The character having sign “-” above H in the formula cannot be expressed in the text of the embodiment, and thus is expressed using the expression “(with sign “-” above H)” as indicated above. The same applies to the following.

Formula 5:

H̅_{d1}=[\sqrt{λ_{d1,1}}u_{d1,1} \sqrt{λ_{d1,2}}u_{d1,2}] (5)

The 2×2 effective desired channel matrix H (with sign “-” above H)_{d1} thus obtained by the channel combiner 112, which is degenerated into a matrix size of 2×2, has elements of the 2×3 desired channel matrix H_{d1} extracted. The two column elements of the effective desired channel matrix H (with sign “-” above H) d1 can be said to be representative elements of desired space to aim at. As the number of rows of the matrix shows, the degree of freedom of the array of the MS 50 is Nrx=2, and the number of columns is also two. The channel combiner 112 obtains the 2×2 effective desired channel matrix H (with sign “-” above H)_{d1}, so that the radio communication apparatus 100 can form directivity within the degree of freedom of the array of the MS 50.

In addition to the above-described approach using singular value decomposition or eigenvalue decomposition, methods of bringing the size of the channel matrix into the degree of freedom of the array of the MS 50 include a method that combines some channel responses together by adding these channel responses to one another. For example, as shown in formula (6), the channel combiner 112 may combine the channel response vectors of the BS d12 and the BS d13 by adding these response vectors to one another, such that the combined channel response vector and the channel response vector of the BS d11 form a 2×2 channel matrix as the effective desired channel matrix H (with sign “-” above H)_{d1}.

Formula 6:

H̅_{d1}=[h_{d11}h_{d12}+h_{d13}] (6)

The same applies to the 2×3 interference channel matrix Hᵤ₁. The channel combiner 112 may likewise obtain eigenvalues and eigenvectors by the eigenvalue decomposition of Hᵤ₁Hᵤ₁^{H} as shown in formula (7) and, using these eigenvalues and eigenvectors, obtain a 2×2 effective interference channel matrix H (with sign “-” above H)ᵤ₁ as shown in formula (8). Consequently, the channel combiner 112 can extract representative elements of the interference that should be suppressed by directivity control, such that the radio communication apparatus 100 can suppress the interference within the degree of freedom of the array of the MS 50.

$$\begin{matrix}Formula 7 & \\ {H}_{u 1} {H}_{u 1}^{H} = [ {u}_{u 1 , 1} {u}_{u 1 , 2} ] [ \begin{matrix}{λ}_{u 1 , 1} & 0 \\ 0 & {λ}_{u 1 , 2}\end{matrix} ] [ \begin{matrix}{u}_{u 1 , 1}^{H} \\ {u}_{u 1 , 2}^{H}\end{matrix} ] & ( 7 )\end{matrix}$$

Formula 8:

H̅ᵤ₁=[\sqrt{λ_{u1,1}}u_{u1,1} \sqrt{λ_{u1,2}}u_{u1,2}] (8)

The same as discussed in relation to the above-described desired elements applies to the interference elements. Through the above cited method, the channel combiner 112 combines some channel responses by adding these channel responses to one another, into the 2×2 effective interference channel matrix H (with sign “-” above H)ᵤ₁. For example, as shown in formula (9), the channel combiner 112 may combine the channel response vectors of the BS u11 and the BS u12 by adding these channel response vectors to each other, such that the combined channel response vector and the channel response vector of the BS d14 form a 2×2 channel matrix as the effective interference channel matrix H (with sign “-” above H)ᵤ₁.

Formula 9:

H̅ᵤ₁=[hᵤ₁₁+hᵤ₁₂h_{d14}] (9)

The channel combiner 112 obtains the effective desired channel matrix and the effective interference channel matrix by the above operations. Thus, the channel combiner 112 combines, for desired BSs, channel responses of one or more BSs into an Nrx×Nrx effective desired channel matrix, and combines, for interference BSs, channel responses of one or more BSs into an Nrx×Nrx effective interference channel matrix. Note that when the number of desired BSs selected by the channel selector 111 is two or less, the channel combiner 112 makes a desired channel matrix itself an effective desired channel matrix because the two or less desired BSs selected by the channel selector 111 allows directivity to be formed within the degree of freedom of the array. Likewise, when the number of interference BSs is two or less, the channel combiner 112 makes an interference channel matrix itself an effective interference channel matrix.

The directivity controller 103 obtains a directivity control weight matrix from the effective desired channel matrix and the effective interference channel matrix obtained by the channel combiner 112, and multiplies the received signals by the directivity control weight matrix. Various algorithms are applicable in calculating the directivity control weight matrix to achieve interference suppression. Such algorithms include, for example, a minimum mean square error (MMSE) algorithm shown in formula (10) and a whitening algorithm shown in formula (11).

Formula 10:

W=H̅_{d1}^{H}(H̅_{d1}H̅_{d1}^{H}+H̅ᵤ₁H̅ᵤ₁^{H}+σ²I)⁻¹ (10)

$$\begin{matrix}Formula 11 & \\ W = {( {\overline{H}}_{u 1} {\overline{H}}_{u 1}^{H} + {σ}^{2} I )}^{- \frac{1}{2}} & ( 11 )\end{matrix}$$

In formulas (10) and (11), σ² represents thermal noise power expected at the receiving end, and I is an identity matrix. The inclusion of the addition term σ²I in a calculation part of the inverse matrix or the square root of the inverse matrix allows suppression providing against both interference and thermal noise, and is also intended to avoid the instability of matrix operations. Note that the directivity controller 103 is not limited to these algorithms given as examples, and can apply other weight calculation algorithms.

Although the present embodiment has been described focusing on directivity control on received signals, an effective desired channel matrix and an effective interference channel matrix obtained by the operations of the channel selector 111 and the channel combiner 112 are also applicable to directivity control in uplink communication from the MS 50 to the BSs.

Next, a hardware configuration of the radio communication apparatus 100 will be described. In the radio communication apparatus 100, the plurality of antennas 101 is implemented by an array antenna. The synchronizer 102, the directivity controller 103, the demodulator 104, the channel estimator 110, the channel selector 111, and the channel combiner 112 are implemented by processing circuitry. The processing circuitry may be a processor for executing a program stored in memory and the memory, or may be dedicated hardware. The processing circuitry is also referred to as a control circuit.

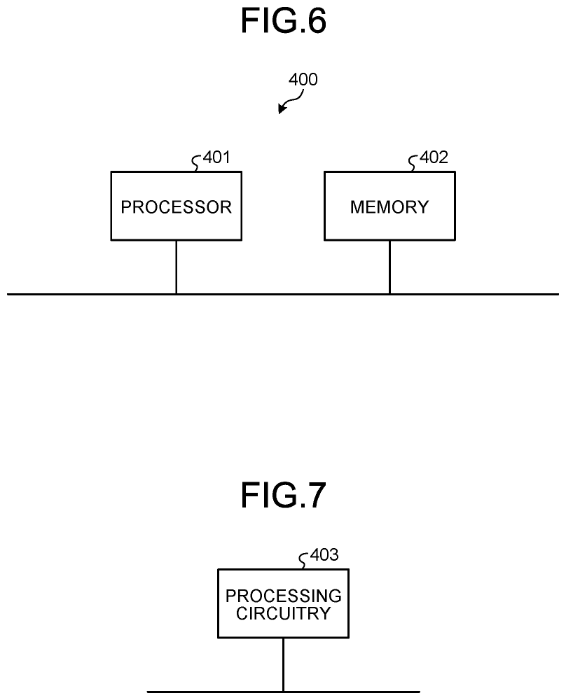

FIG. 6 is a diagram illustrating an example configuration of processing circuitry 400 when the processing circuitry included in the radio communication apparatus 100 according to the first embodiment is implemented by a processor 401 and memory 402. The processing circuitry 400 illustrated in FIG. 6 is a control circuit and includes the processor 401 and the memory 402. When the processor 401 and the memory 402 constitute the processing circuitry 400, the functions of the processing circuitry 400 are implemented by software, firmware, or a combination of software and firmware. The software or firmware is described as a program and stored in the memory 402. In the processing circuitry 400, the processor 401 reads and executes the program stored in the memory 402, thereby implementing each function. That is, the processing circuitry 400 includes the memory 402 for storing the program that results in the execution of processing in the radio communication apparatus 100. This program can be said to be a program for causing the radio communication apparatus 100 to perform each function implemented by the processing circuitry 400. This program may be provided by a storage medium in which the program is stored, or may be provided by another means such as a communication medium.

The program can be said to be a program that causes the radio communication apparatus 100 to: perform an estimation step in which the channel estimator 110 estimates virtual cell identification information identifying virtual cells to which BSs belong, channel responses for each antenna 101, and arrival delay amounts for each antenna 101, the virtual cell identification information identifying the virtual cell to which BSs belong; a selection step in which the channel selector 111 calculates the channel power level of each BS from the channel responses for each antenna 101, calculates the arrival delay amount of each BS from the arrival delay amounts for each antenna 101, and selects one or more desired BSs and interference BSs from the virtual cell identification information, the channel power levels, and the arrival delay amounts; a combining step in which on the basis of the number of the antennas 101, the channel combiner 112 combines the channel responses of one or more of the BSs into one effective desired channel matrix, and combines the channel responses of one or more of the BSs into one effective interference channel matrix, the one or more of the BSs being the desired BSs, the one or more of the BSs being the interference BSs, and a control step in which the directivity controller 103 controls directivity, using the effective desired channel matrix and the effective interference channel matrix.

The processor 401 is, for example, a central processing unit (CPU), a processing unit, an arithmetic unit, a microprocessor, a microcomputer, a digital signal processor (DSP), or the like. The memory 402 corresponds, for example, to nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disk, a mini disk, a digital versatile disc (DVD), or the like.

FIG. 7 is a diagram illustrating an example of processing circuitry 403 when dedicated hardware constitutes the processing circuitry included in the radio communication apparatus 100 according to the first embodiment. The processing circuitry 403 illustrated in FIG. 7 corresponds, for example, to a single circuit, a combined circuit, a programmed processor, a parallel-programmed processor, an application-specific integrated circuit (ASIC), a field-programmable gate array (FPGA), or a combination of them. The processing circuitry may be implemented partly by dedicated hardware and partly by software or firmware. Thus, the processing circuitry can implement the above-described functions by dedicated hardware, software, firmware, or a combination of them.

As described above, according to the present embodiment, in the wireless communication system 1 that performs multi-station simultaneous transmission, the radio communication apparatus 100 of the MS 50 selects desired channels and interference channels and combines or degenerates channel matrices into dimensions within the degree of freedom of the array of the MS 50 even when signals outnumbering the degree of freedom of the array of the MS 50 arrive at the radio communication apparatus 100. Consequently, the radio communication apparatus 100 can perform proper directivity control and can suppress interference signals.

### Second Embodiment

In the first embodiment, each BS includes one antenna. A second embodiment will be described assuming that each BS includes two or more antennas. For the purpose of simplicity of the following description, each BS is defined as including two antennas (Ntx=2). The other preconditions are the same as those in the first embodiment. Thus, the channel response between each BS and the MS 50 is represented by a 2×2 channel response matrix.

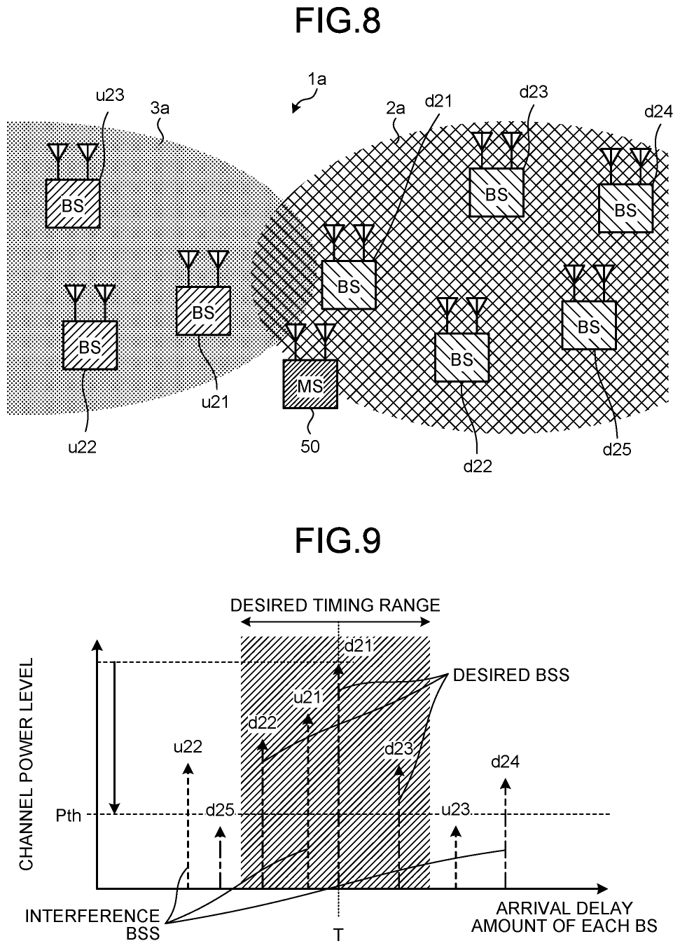

FIG. 8 is a diagram illustrating an example configuration of a wireless communication system 1a according to the second embodiment. The wireless communication system 1a includes the MS 50 and BSs d21 to d25 and u21 to u23. In FIG. 8, the MS 50 belongs to a desired cell 2a that is a virtual cell formed by the BSs d21 to d25. As illustrated in FIG. 8, the MS 50 is in a boundary area of the desired cell 2a. Thus, for the MS 50, a virtual cell formed by the BSs u21 to u23 is an interference cell 3a. In the following description, the BSs d21 to d25 and u21 to u23 are sometimes simply referred to as BSs when not distinguished. FIG. 8 illustrates an image of the positional relationships between the MS 50 and the BSs in the wireless communication system 1a.

As illustrated in FIG. 8, the BSs in the desired cell 2a observable from the MS 50 are five stations BS d21 to BS d25, and the BSs in the interference cell 3a observable from the MS 50 are three stations BS u21 to BS u23. Thus, the MS 50 receives transmission signals from the BSs d21 to d25 in the desired cell 2a as desired signals, and signals from the BSs u21 to u23 in the interference cell 3a are interference. The present embodiment will be described taking, for example, downlink communication in which the BSs transmit signals and the MS 50 receives the signals.

In the present embodiment, the operation of the channel combiner 112 of the radio communication apparatus 100 of the MS 50 is different from that in the first embodiment. Thus, the operation of the channel combiner 112, which is a difference from the first embodiment, will be mainly described.

The channel selector 111, which precedes the channel combiner 112, performs the same operation as discussed in the first embodiment to thereby obtain a map of the arrival delay amount and the channel power level of each BS as illustrated in FIG. 9. FIG. 9 is a diagram illustrating the map of the arrival delay amount and the channel power level of each BS obtained by the channel selector 111 of the radio communication apparatus 100 according to the second embodiment. As illustrated in FIG. 9, as a result of channel selection, the channel selector 111 selects three desired BSs, i.e., BSs d21, d22, and d23 (M=3), and selects three interference BSs, i.e., BSs u21, u22, and d24 (N=3).

The channel combiner 112 defines channel response vectors for the BSs selected by the channel selector 111. As regards the desired BSs, a 2×2 channel response matrix between the BS d21 and the MS 50 is defined as H_{d21}, a 2×2 channel response matrix between the BS d22 and the MS 50 as H_{d22}, and a 2×2 channel response matrix between the BS d23 and the MS 50 as H_{d23}. Likewise, regarding the interference BSs, a 2×2 channel response matrix between the BS u21 and the MS 50 is defined as Hᵤ₂₁, a 2×2 channel response matrix between the BS u22 and the MS 50 as Hᵤ₂₂, and a 2×2 channel response matrix between the BS d24 and the MS 50 as H_{d24}. The channel combiner 112 defines elements of these channel response matrices as expressed in formula (12).

$$\begin{matrix}Formula 12 & \\ {H}_{d 21} = [ {h}_{d 21 , 1} {h}_{d 21 , 2} ] = [ \begin{matrix}{h}_{d 21 , 11} & {h}_{d 21 , 12} \\ {h}_{d 21 , 21} & {h}_{d 21 , 22}\end{matrix} ] , & ( 12 )\end{matrix}$$

$${H}_{d 22} = [ {h}_{d 22 , 1} {h}_{d 22 , 2} ] = [ \begin{matrix}{h}_{d 22 , 11} & {h}_{d 22 , 12} \\ {h}_{d 22 , 21} & {h}_{d 22 , 22}\end{matrix} ] ,$$

$${H}_{d 23} = [ {h}_{d 23 , 1} {h}_{d 23 , 2} ] = [ \begin{matrix}{h}_{d 23 , 11} & {h}_{d 23 , 12} \\ {h}_{d 23 , 21} & {h}_{d 23 , 22}\end{matrix} ] ,$$

$${H}_{u 21} = [ {h}_{u 21 , 1} {h}_{u 21 , 2} ] = [ \begin{matrix}{h}_{u 21 , 11} & {h}_{u 21 , 12} \\ {h}_{u 21 , 21} & {h}_{u 21 , 22}\end{matrix} ] ,$$

$${H}_{u 22} = [ {h}_{u 22 , 1} {h}_{u 22 , 2} ] = [ \begin{matrix}{h}_{u 22 , 11} & {h}_{u 22 , 12} \\ {h}_{u 22 , 21} & {h}_{u 22 , 22}\end{matrix} ] ,$$

$${H}_{d 24} = [ {h}_{d 24 , 1} {h}_{d 24 , 2} ] = [ \begin{matrix}{h}_{d 24 , 11} & {h}_{d 24 , 12} \\ {h}_{d 24 , 21} & {h}_{d 24 , 22}\end{matrix} ]$$

In formula (12) , h_{d21,1} and h_{d21,2} are column vectors defining H_{d21}, h_{d22,1} and h_{d22,2} are column vectors defining H_{d22}, and h_{d23,1} and h_{d23,2} are column vectors defining H_{d23}. Likewise, h_{d23,1} and h_{u21,2} are column vectors defining H_{u,21}, h_{u22,1} and h_{u22,2} are column vectors defining Hᵤ₂₂, and h_{d24,1} and h_{d24,2} are column vectors defining H_{d24}.

Next, the channel combiner 112 defines a 2×6 desired channel matrix H_{d2} having the channel response matrices of the selected desired BSs arranged in the column direction as expressed in formula (13).

Formula 13:

H_{d2}=[H_{d21}H_{d22}H_{d23}] (13)

Likewise, the channel combiner 112 defines a 2×6 interference channel matrix Hᵤ₂ having the channel response vectors of the selected interference BSs arranged in the column direction as in formula (14).

Formula 14:

Hᵤ₂=[Hᵤ₂₁Hᵤ₂₂H_{d24}] (14)

In both the 2×6 desired channel matrix H_{d2} in formula (13) and the 2×6 interference channel matrix Hᵤ₂ in formula (14), the matrix row direction corresponds to the antenna space of the MS 50, and the matrix column direction corresponds to the antenna space of the BSs. The 2×6 desired channel matrix H_{d2} in formula (13) has two singular values or eigenvalues. For this reason, the channel combiner 112 can extract singular values and singular vectors by the singular value decomposition of H_{d2}, or can extract eigenvalues and eigenvectors by the eigenvalue decomposition of H_{d2}H_{d2}^{H}. The channel combiner 112 is defined as performing the latter decomposition, i.e., the eigenvalue decomposition of H_{d2}H_{d2}^{H} by way of example, as expressed as in formula (15).

$$\begin{matrix}Formula 15 & \\ {H}_{d 2} {H}_{d 2}^{H} = [ {u}_{d 2 , 1} {u}_{d 2 , 2} ] [ \begin{matrix}{λ}_{d 2 , 1} & 0 \\ 0 & {λ}_{d 2 , 2}\end{matrix} ] [ \begin{matrix}{u}_{d 2 , 1}^{H} \\ {u}_{d 2 , 2}^{H}\end{matrix} ] & ( 15 )\end{matrix}$$

λ_{d2,1} and λ_{d2,2} are eigenvalues, and u_{d2,1} and u_{d2,2} are eigenvectors. Using these eigenvalues and eigenvectors, the channel combiner 112 obtains a 2×2 effective desired channel matrix H (with sign “-” above H) d2 as in formula (16).

Formula 16:

H̅_{d2}=[\sqrt{λ_{d2,1}}u_{d2,1} \sqrt{λλ_{d2,2}}u_{d2,2}] (16)

The 2×2 effective desired channel matrix H (with sign “-” above H)_{d2} thus obtained by the channel combiner 112, which is degenerated into a matrix size of 2×2, has elements of the 2×6 desired channel matrix H_{d2} extracted. The two column elements of the effective desired channel matrix H (with sign “-” above H)_{d2} can be said to be representative elements of desired space to aim at. As the number of rows of the matrix shows, the degree of freedom of the array of the MS 50 is Nrx=2, and the number of columns is also two. The channel combiner 112 obtains the 2×2 effective desired channel matrix H (with sign “-” above H)_{d2}, so that the radio communication apparatus 100 can form directivity within the degree of freedom of the array of the MS 50.

Methods of bringing the size of the channel matrix into the degree of freedom of the array of the MS 50 include a method that combines part or all of the channel responses together by adding the part or all of these channel responses to one another, as in the first embodiment. For example, as shown in formula (17), the channel combiner 112 may combine the channel response matrices of the BS d21, the BS d22, and the BS d23 by adding these channel response matrices to one another, into the effective desired channel matrix H (with sign “-” above H)_{d2}.

Formula 17:

H̅_{d2}=H_{d21}+H_{d22}+H_{d23} (17)

The same applies to the 2×6 interference channel matrix Hᵤ₂. The channel combiner 112 may likewise obtain eigenvalues and eigenvectors by the eigenvalue decomposition of Hᵤ₂Hᵤ₂^{H} as shown in formula (18), and obtain a 2×2 effective interference channel matrix H (with sign “-” above H)ᵤ₂ as shown in formula (19). Consequently, the channel combiner 112 can extract representative elements of the interference that should be suppressed by directivity control, and the radio communication apparatus 100 can suppress the interference within the degree of freedom of the array of the MS 50.

$$\begin{matrix}Formula 18 & \\ {H}_{u 2} {H}_{u 2}^{H} = [ {u}_{u 2 , 1} {u}_{u 2 , 2} ] [ \begin{matrix}{λ}_{u 2 , 1} & 0 \\ 0 & {λ}_{u 2 , 2}\end{matrix} ] [ \begin{matrix}{u}_{u 2 , 1}^{H} \\ {u}_{u 2 , 2}^{H}\end{matrix} ] & ( 18 )\end{matrix}$$

$$\begin{matrix}Formula 19 & \\ {\overline{H}}_{u 2} = [ \sqrt{{λ}_{u 2 , 1}} {u}_{u 2 , 1} \sqrt{{λ}_{u 2 , 2}} {u}_{u 2 , 2} ] & ( 19 )\end{matrix}$$

The same as discussed in relation to the above-described desired elements applies to the interference elements. Through the above cited method, the channel combiner 112 combines part or all of the channel responses together by adding part or all of these channel responses to one another, into the 2×2 effective interference channel matrix H (with sign “-” above H) For example, as shown in formula (20), the channel combiner 112 may combine the channel response matrices of the BS u21, the BS u22, and the BS d24 by adding these channel response matrices to one another, into the effective interference channel matrix H (with sign “-” above H)ᵤ₂.

Formula 20:

H̅ᵤ₂=Hᵤ₂₁+Hᵤ₂₂+H_{d24} (20)

The channel combiner 112 obtains the effective desired channel matrix and the effective interference channel matrix by the above operations. Thus, the channel combiner 112 combines, BS antenna-by-BS antenna, the channel vectors of a plurality of BSs into one effective desired channel vector and one effective interference vector. The channel combiner 112 generates an NrxxNtx effective desired channel matrix, using the phase difference between the antennas of the BSs and the effective desired channel vectors corresponding to the individual antennas of the BSs. Likewise, the channel combiner 112 generates an Nrx×Ntx effective interference channel matrix, using the phase difference between the antennas of the BSs and the effective interference channel vectors corresponding to the individual antennas of the BSs. Note that when the number of desired BSs selected by the channel selector 111 is M=1, the channel combiner 112 makes a desired channel matrix itself an effective desired channel matrix because M=1 allows directivity to be formed within the degree of freedom of the array. Likewise, when the number of interference BSs is N=1, the channel combiner 112 makes an interference channel matrix itself an effective interference channel matrix.

Although the present embodiment has been described focusing on directivity control on received signals, an effective desired channel matrix and an effective interference channel matrix obtained by the operations of the channel selector 111 and the channel combiner 112 are also applicable to directivity control in uplink communication from the MS 50 to the BSs.

As described above, according to the present embodiment, in the wireless communication system la that performs multi-station simultaneous transmission with each BS including a plurality of independent antennas, the radio communication apparatus 100 of the MS 50 selects desired channels and interference channels and combines or degenerates channel matrices into dimensions within the degree of freedom of the array of the MS 50 even when signals outnumbering the degree of freedom of the array of the MS 50 arrive at the radio communication apparatus 100. Thus, as in the first embodiment, the radio communication apparatus 100 can perform proper directivity control and can suppress interference signals.

### Third Embodiment

A third embodiment will describe the wireless communication system la as found in the second embodiment, in which system each BS transmits a signal to which transmission diversity by space-time coding or space-frequency coding has been applied.

Examples of space-time coding include space-time block coding (STBC) and differential space-time block coding (DSTBC). Examples of space-frequency coding include space-frequency block coding (SFBC) and differential space-frequency block coding (DSFBC). These transmission diversity techniques perform block coding by exchanging transmission signals between transmitting antennas or between transmission layers when precoding is applied, and performing complex conjugation, sign inversion, etc. Therefore, for demodulation, the MS 50 at the receiving end needs to identify transmitting antennas or transmitting layers when precoding is applied, and estimate their respective channel responses.

Thus, in the present embodiment, the channel combiner 112 performs channel combining or degeneration BS transmission antenna-by-BS transmission antenna. The following description will made focusing on a difference from the second embodiment. Although the description of channel combining or degeneration on each transmission layer when precoding is applied is omitted, one of ordinary skill in the art can easily conceive of applying the same technique only by replacing transmitting antennas defined in the present embodiment with transmission layers.

Assume that channel selection results in the channel selector 111 are the same as those in the second embodiment. First, as in formula (21), the channel combiner 112 obtains a 2×3 matrix H_{d3a} made up of only the first-column vectors of the 2×2 channel response matrices of the individual desired BSs are combined, and a 2×3 matrix H_{d3b} made up of only the second-column vectors. The column vectors are defined by formula (12).

$$\begin{matrix}Formula 21 & \\ {H}_{d 3 a} = [ {h}_{d 21 , 1} {h}_{d 22 , 1} {h}_{d 23 , 1} ] & ( 21 )\end{matrix}$$

$${H}_{d 3 b} = [ {h}_{d 21 , 2} {h}_{d 22 , 2} {h}_{d 23 , 2} ]$$

Next, the channel combiner 112 degenerates each of the matrices H_{d3a} and H_{d3b} into a 2×1 column vector. Degeneration methods include, as described above, a method expressed in formula (22), formula (23), etc. using a first singular value obtained by singular value decomposition, or the square root of a first eigenvalue obtained by eigenvalue decomposition and the corresponding eigenvector, and a method expressed in formula (24) that combines the column vectors in the matrix together by adding these column vectors to one another. Using any one of the methods, the channel combiner 112 obtains a 2×1 vector h_{d3a} as a result of degeneration of the matrix H_{d3a} and a 2×1 vector h_{d3b} as a result of degeneration of the matrix H_{d3b}. These two vectors include representative elements that express a set of three antennas each of which is one of the antennas of the corresponding one of the three stations, i.e., desired BSs, and representative elements that express a set of three antennas each of which is the other antenna of the corresponding one of the three desired BSs.

$$\begin{matrix}Formula 22 & \\ {H}_{d 3 a} {H}_{d 3 a}^{H} = [ {u}_{d 3 a , 1} {u}_{d 3 a , 2} ] [ \begin{matrix}{λ}_{d 3 a , 1} & 0 \\ 0 & {λ}_{d 3 a , 2}\end{matrix} ] [ \begin{matrix}{u}_{d 3 a , 1}^{H} \\ {u}_{d 3 a , 2}^{H}\end{matrix} ] & ( 22 )\end{matrix}$$

$$\begin{matrix}Formula 23 & \\ {h}_{d 3 a} = \sqrt{{λ}_{d 3 a , 1}} {u}_{d 3 a , 1} & ( 23 )\end{matrix}$$

$$\begin{matrix}Formula 24 & \\ {h}_{d 3 a} = {h}_{d 21 , 1} + {h}_{d 22 , 1} + {h}_{d 23 , 1} & ( 24 )\end{matrix}$$

When the method using eigenvectors shown in formula (22), formula (23), etc. is applied, phase uncertainty due to the operation method is inherent in the two 2×1 vectors h_{d3a} and h_{d3b} obtained. To reflect the phase relationships between the BS antennas properly in these two vectors obtained using the eigenvectors, the channel combiner 112 obtains an average phase difference. As shown in formula (25), the channel combiner 112 obtains a complex scalar value α_{d3} by taking the inner product of a 6×1 vector defined by the column vectors in H_{d3a} stacked in the row direction and a 6×1 vector defined by the column vectors in H_{d3b} stacked in the row direction. α_{d3} is normalized by the absolute value |α_{d3}| into an argument phase rotator. When the two 2×1 vectors are combinations of the column vectors in the matrices, obtained by adding these column vectors to one another, as shown in formula (24), α_{d3}=1 because the phase relationships between the BS antennas are reflected.

Formula 25:

α_{d3}=[h_{d21,1}^{H}h_{d22,1}^{H}h_{d23,1}^{H}h_{d21,2}^{H}h_{d22.2}^{H}h_{d23,2}]^{H} (25)

Using h_{d3a} and h_{d3b}, and α_{d3} obtained, the channel combiner 112 can obtain a 2×2 effective desired channel matrix H (with sign “-” above H)_{d3} as shown in formula (26).

$$\begin{matrix}Formula 26 & \\ {\overline{H}}_{d 3} = [ {h}_{d 3 a} \frac{{α}_{d 3}}{\vert {α}_{d 3} \vert} {h}_{d 3 b} ] & ( 26 )\end{matrix}$$

Although not discussed, it can be easily understood that the channel combiner 112 performs similar calculations to thereby obtain a 2×2 effective interference channel matrix H (with sign “-” above H)ᵤ₃. Even when the BSs apply transmission diversity, proper directivity control can be performed using the 2×2 effective desired channel matrix H (with sign “-” above H) d3 and the 2×2 effective interference channel matrix H (with sign “-” above H)ᵤ₃.

As described above, according to the present embodiment, in the wireless communication system 1a in which each BS includes a plurality of independent antennas and performs multi-station simultaneous transmission, and further each BS transmits a signal, applying transmission diversity by space-time coding or space-frequency coding, the radio communication apparatus 100 of the MS 50 selects desired channels and interference channels and combines or degenerates channel matrices into dimensions within the degree of freedom of the array of the MS 50 even when signals outnumbering the degree of freedom of the array of the MS 50 arrive at the radio communication apparatus 100. Thus, the radio communication apparatus 100 can perform proper directivity control and can suppress interference signals as in the second embodiment.

The radio communication apparatus according to the present disclosure has the effect of properly controlling the directivity of the antennas even when the signals outnumbering exceeding the antennas arrive at the radio communication apparatus.

The configurations described in the above embodiments illustrate an example and can be combined with another known art. The embodiments can be combined with each other. The configurations can be partly omitted or changed without departing from the gist.

What is claimed is:

1. A radio communication apparatus in a wireless communication system including a plurality of ground base stations handling the same signals with the same frequencies to form a virtual cell, and an adjacent virtual cell also using the same frequencies, the radio communication apparatus receiving the same signals, using a plurality of antennas, the radio communication apparatus comprising:
channel estimation circuitry to estimate virtual cell identification information, channel responses for each antenna, and arrival delay amounts for each antenna, the virtual cell identification information identifying the virtual cell to which the ground base stations belong;
channel selection circuitry to calculate a channel power level of each ground base station from the channel responses for each antenna, calculate an arrival delay amount of each ground base station from the arrival delay amounts for each antenna, and select one or more desired ground base stations and interference ground base stations from the virtual cell identification information, the channel power levels, and the arrival delay amounts;
channel combination circuitry to, on a basis of the number of the antennas, combine the channel responses of one or more of the ground base stations into one effective desired channel matrix, and combine the channel responses of one or more of the ground base stations into one effective interference channel matrix, the one or more of the ground base stations being the desired ground base stations, the one or more of the ground base stations being the interference ground base stations; and
directivity control circuitry to control directivity, using the effective desired channel matrix and the effective interference channel matrix.

2. The radio communication apparatus according to claim 1, wherein
the radio communication apparatus includes Nrx antennas as the plurality of antennas, and
the channel combination circuitry combines, for the desired ground base stations, the channel responses of one or more of the ground base stations into an Nrx×Nrx effective desired channel matrix, and combines, for the interference ground base stations, the channel responses of one or more of the ground base stations into an Nrx×Nrx effective interference channel matrix.

3. The radio communication apparatus according to claim 1, wherein
the ground base stations include Ntx antennas as a plurality of antennas,
the radio communication apparatus includes Nrx antennas as the plurality of antennas,
the channel combination circuitry combines, ground-base-station-antenna-by-ground-base-station-antenna, channel vectors of two or more of the ground base stations into one effective desired channel vector and one effective interference vector, and
the channel combination circuitry generates an NrxxNtx effective desired channel matrix, using a phase difference between the antennas of the ground base stations and the effective desired channel vectors corresponding to the individual antennas of the ground base stations, and generates an Nrx×Ntx effective interference channel matrix, using a phase difference between the antennas of the ground base stations and the effective interference channel vectors corresponding to the individual antennas of the ground base stations.

4. The radio communication apparatus according to claim 1, wherein
in combining the channel responses, the channel combination circuitry obtains the effective desired channel matrix and the effective interference channel matrix from eigenvalues and eigenvectors obtained by eigenvalue decomposition.

5. The radio communication apparatus according to claim 2, wherein
in combining the channel responses, the channel combination circuitry obtains the effective desired channel matrix and the effective interference channel matrix from eigenvalues and eigenvectors obtained by eigenvalue decomposition.

6. The radio communication apparatus according to claim 3, wherein
in combining the channel responses, the channel combination circuitry obtains the effective desired channel matrix and the effective interference channel matrix from eigenvalues and eigenvectors obtained by eigenvalue decomposition.

7. The radio communication apparatus according to claim 1, wherein
in combining the channel responses, the channel combination circuitry combines part or all of the channel responses together by adding the part or all of the channel responses to one another, to thereby obtain the effective desired channel matrix and the effective interference channel matrix.

8. The radio communication apparatus according to claim 2, wherein
in combining the channel responses, the channel combination circuitry combines part or all of the channel responses together by adding the part or all of the channel responses to one another, to thereby obtain the effective desired channel matrix and the effective interference channel matrix.

9. The radio communication apparatus according to claim 3, wherein
in combining the channel responses, the channel combination circuitry combines part or all of the channel responses together by adding the part or all of the channel responses to one another, to thereby obtain the effective desired channel matrix and the effective interference channel matrix.

10. The radio communication apparatus according to claim 1, wherein
the channel selection circuitry sets a reference timing that is an arrival delay amount of a desired ground base station having the highest channel power level, sets a channel power threshold with reference to the channel power level of the desired ground base station having the highest channel power level, and selects, as the desired ground base stations, ground base stations belonging to a desired virtual cell and having a channel power level higher than or equal to the channel power threshold in a predetermined range centering the reference timing.

11. The radio communication apparatus according to claim 2, wherein
the channel selection circuitry sets a reference timing that is an arrival delay amount of a desired ground base station having the highest channel power level, sets a channel power threshold with reference to the channel power level of the desired ground base station having the highest channel power level, and selects, as the desired ground base stations, ground base stations belonging to a desired virtual cell and having a channel power level higher than or equal to the channel power threshold in a predetermined range centering the reference timing.

12. The radio communication apparatus according to claim 3, wherein
the channel selection circuitry sets a reference timing that is an arrival delay amount of a desired ground base station having the highest channel power level, sets a channel power threshold with reference to the channel power level of the desired ground base station having the highest channel power level, and selects, as the desired ground base stations, ground base stations belonging to a desired virtual cell and having a channel power level higher than or equal to the channel power threshold in a predetermined range centering the reference timing.

13. A control circuit to control a radio communication apparatus in a wireless communication system including a plurality of ground base stations handling the same signals with the same frequencies to form a virtual cell, and an adjacent virtual cell also using the same frequencies, the radio communication apparatus receiving the same signals, using a plurality of antennas, the control circuit causing the radio communication apparatus to
estimate virtual cell identification information, channel responses for each antenna, and arrival delay amounts for each antenna, the virtual cell identification information identifying the virtual cell to which the ground base stations belong
calculate a channel power level of each ground base station from the channel responses for each antenna, calculate an arrival delay amount of each ground base station from the arrival delay amounts for each antenna, and select one or more desired ground base stations and interference ground base stations from the virtual cell identification information, the channel power levels, and the arrival delay amounts,
on a basis of the number of the antennas, combine the channel responses of one or more of the ground base stations into one effective desired channel matrix, and combine the channel responses of one or more of the ground base stations into one effective interference channel matrix, the one or more of the ground base stations being the desired ground base stations, the one or more of the ground base stations being the interference ground base stations, and
control directivity, using the effective desired channel matrix and the effective interference channel matrix.

14. A non-transitory storage medium storing a program to control a radio communication apparatus in a wireless communication system including a plurality of ground base stations handling the same signals with the same frequencies to form a virtual cell, and an adjacent virtual cell also using the same frequencies, the radio communication apparatus receiving the same signals, using a plurality of antennas,
the program causing the radio communication apparatus to
estimate virtual cell identification information, channel responses for each antenna, and arrival delay amounts for each antenna, the virtual cell identification information identifying the virtual cell to which the ground base stations belong
calculate a channel power level of each ground base station from the channel responses for each antenna, calculate an arrival delay amount of each ground base station from the arrival delay amounts for each antenna, and select one or more desired ground base stations and interference ground base stations from the virtual cell identification information, the channel power levels, and the arrival delay amounts,
on a basis of the number of the antennas, combine the channel responses of one or more of the ground base stations into one effective desired channel matrix, and combine the channel responses of one or more of the ground base stations into one effective interference channel matrix, the one or more of the ground base stations being the desired ground base stations, the one or more of the ground base stations being the interference ground base stations, and
control directivity, using the effective desired channel matrix and the effective interference channel matrix.
